(19) United States
(12) Patent Application Publication
(10) Pub. No.: US 2008/0137239 A1
(43) Pub. Date: Jun. 12, 2008

(54) Motor power device and motor including the same

(76) Inventor: Ho Jae Lee, Gimhae-si (KR)

Correspondence Address: MCKENNA LONG & ALDRIDGE LLP;Song K. Jung, 1900 K Street, N.W., Washington, DC, 20006, US

(21) Appl. No.: 11/655,824

(22) Filed: Jan. 22, 2007

(30) Foreign Application Priority Data
Dec. 6, 2006 (KR) 10-2006-0123002

(51) Int. Cl. H02H 7/08

(52) U.S. Cl. 361/23

(57) ABSTRACT

A motor power device includes a power circuit having a low voltage part that receives and converts AC power and outputs DC voltage, wherein a first power for a motor drive coil and a second power for a control circuit controlling the motor drive coil are supplied by using the DC voltage outputted from the power circuit, and a motor may include the motor power device. In one aspect, a motor power device is provided that may supply a DC voltage by using an AC power regardless of the magnitude of the AC power. In another aspect, a power circuit may output suitable DC voltage with less cost even though the magnitude of the AC power has changed. In yet another aspect, a motor power device is provided that may supply power for driving a motor drive coil and a power for a control circuit controlling the motor drive coil using one power circuit.

This application claims the benefit of the Patent Korean Application No. 10-2006-0123002, filed on Dec. 6, 2006, which is hereby incorporated by reference as if fully set forth herein.

### BACKGROUND OF THE INVENTION

1. Field of the Invention

The present invention relates to a motor power device, more particularly, to a motor power device, which supplies the power needed to operate a motor and a control circuit controlling the motor, and a motor including the same that is easily fabricated with enhanced efficiency and durability, and which has a compact structure convenient to a user.

2. Discussion of the Related Art

Recently, a DC motor has been adapted instead of a shading coil type AC motor as a motor for cold air circulation of a refrigerator, for example. This is because energy loss rate of a shading coil AC motor is 80% of the inputted energy, which is higher than a DC motor.

However, an external DC power supply device has to be additionally provided outside of the DC motor to supply the DC power to the motor. Because the modern trend is to provide a motor that is small, lean, and light, it is difficult to secure space in which to hold the DC motor having the external DC power supply device.

Also, because the external DC power supply device has to be fabricated separately from the motor, there is a problem of complex work process/high cost.

For this reason, the DC power is not applied to the DC motor and AC power is converted into DC power through a DC power supply circuit that is configured as one body with a motor drive operation. Thereby, a control circuit is capable of controlling a motor without the use of an auxiliary external DC power supply device.

FIG. 1 illustrates a structure of a conventional motor power device. A power circuit supplies DC power by converting AC power and the power circuit is configured as one body with a control circuit, which controls the motor drive operation.

As shown in FIG. 1, the conventional motor power device includes a motor power circuit and a control power circuit. The motor power circuit supplies power (V1) needed for operation of motor drive coils (L1) and (L2). The control power circuit supplies power (V2) needed for controlling the motor drive coils (L1) and (L2).

Here, the motor power circuit includes a rectifier circuit and a voltage reduction circuit. The motor power circuit receives AC power to rectify and to convert the rectified high DC voltage into low DC voltage. After that, the motor power circuit supplies the converted low DC voltage to the control circuit as a control power (V2).

The control circuit includes a hall sensor coupled to a motor rotor (not shown) to sense the rotation of the motor and a switching element that switches based on a signal sensed by the hall sensor. The control circuit having the above configuration receives a voltage (V2) of a predetermined level from the control power circuit and controls the switching of the switching element based on the signal sensed by the hall sensor. Thereby, a high DC voltage is applied to both opposite ends of the motor drive coil (L1) and (L2) to drive the motor.

As mentioned before, the motor power device supplies power to the motor drive coils (L1) and (L2) and the control circuit controlling the motor drive coils (L1) and (L2).

However, because AC power can have different values according to country or region, the motor including the motor power device, and components of the conventional motor power device may have to be re-designed to receive the AC power of the country or region, such as a motor drive coil and the like.

That is, a voltage of DC power gained by rectification becomes greater as AC power becomes greater. Thus, beside the motor drive coil, re-design is needed to increase voltage tolerance of various components, such as a switching element.

Because the magnitude of the AC power affects the product design, there are problems of complicated fabrication process, cost of parts increases and products becoming large.

### SUMMARY

Accordingly, the present invention relates to a motor power device and a motor including the same.

An object of the present invention is to provide a motor power device that may supply a low DC voltage by converting AC power regardless of a magnitude of the AC power.

Another object of the present invention is to provide a power circuit that outputs suitable DC voltage with less cost even though the magnitude of the AC power has changed.

A further object of the present invention is to provide a motor power device that may supply a power for driving a motor drive coil and a power for a control circuit controlling the motor drive coil through one power circuit.

A still further object of the present invention is to provide a motor that is convenient to use with improved durability/reliability.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a motor power device includes a power circuit comprising a low voltage part that receives and converts AC power to output low DC voltage, wherein a first power for a motor drive coil and a second power for a control circuit controlling the motor drive coil are supplied by using the low DC voltage outputted from the power circuit.

Here, the low voltage part includes a capacitor that converts the inputted AC power based on a capacitive value of the capacitor. The capacitive value of the capacitor is selected based on a magnitude of the AC power.

The power circuit further includes a protection circuit connected between an AC power terminal and the low voltage part in serial to protect the power circuit against a malfunction of the low voltage part.

The power circuit further includes a rectifier circuit connected to a rear terminal of the low voltage part to rectify the DC voltage outputted from the low voltage part. The power circuit further includes a smoothing circuit connected to the rectifier circuit in parallel to smooth the DC voltage rectified at the rectifier circuit.

The power circuit further includes a voltage drop part connected to an output terminal of the rectifier circuit to lower a level of the DC voltage outputted at the rectifier circuit, and the DC voltage outputted at the rectifier circuit is configured as a second power for a control circuit.

The power circuit further includes a zener diode that regulates and maintains the DC voltage outputted at the voltage drop part. Also, the power circuit further includes a resistor connected to the zener diode in serial to protect the zener diode from overcurrents.

The motor drive coil includes a first coil and a second coil. The control circuit includes a HIC (Hall Integrated Circuit) that senses a rotation of a motor to output a square wave output signal, a signal inverting switch that inverts the output signal of the HIC, a first coil control switch connected to the first coil in serial to switch the first coil on and off based on the output signal outputted at the first coil, and a second coil control switch connected to the second coil in serial to switch the second coil on and off based on the output signal inverted at the signal inverting switch.

In another aspect of the present invention, a motor power device includes a motor power circuit including a first low voltage part that receives and converts AC power to output DC power, and a control power circuit comprising a second low voltage part that receives and converts AC power to output low DC voltage, wherein a first power for a motor drive coil is supplied by using the DC voltage outputted at the motor power circuit and a second power for controlling the motor drive coil is supplied by the low DC voltage outputted at the control power circuit.

Here, the first and second low voltage parts comprise capacitors, respectively, that convert the AC power received/inputted based on the capacitive value of the capacitors. The capacitive value of the capacitor is selected based on the magnitude of the AC power.

The motor power device further includes a protection circuit connected to each front terminal of the first and second low voltage part to protect the motor power circuit and the control power circuit against a malfunction of the first and second low voltage part.

The motor power circuit further includes a rectifier circuit connected to a rear terminal of the first low voltage part to rectify the DC voltage outputted at the first low voltage part, and a smoothing circuit connected to the rectifier circuit in parallel to smooth the DC circuit rectified at the rectifier circuit.

The control power circuit further includes a rectifier circuit connected to the motor drive coil in parallel to receive and rectify the DC voltage outputted at the second low voltage part. The DC voltage outputted at the rectifier circuit is configured as a second power for the control circuit.

The control power circuit further includes a zener diode that regulates and maintains the DC voltage outputted at the rectifier circuit, and a resistor connected to the zener diode in serial to protect the zener diode from overcurrents.

The motor drive coil includes a first coil and a second coil. The control circuit includes a HIC (Hall Integrated Circuit) that senses a rotation of a motor to output a square wave output signal, a signal inverting switch that inverts the output signal of the HIC, a first coil control switch connected to the first coil in serial to switch the first coil on and off based on the output signal outputted at the first coil, and a second coil control switch connected to the second coil in serial to switch the second coil on and off based on the output signal inverted at the signal inverting switch.

In another aspect of the present invention, a motor including the motor power device is presented.

It is to be understood that both the foregoing general description and the following detailed description are exemplary and explanatory and are not intended to limit the scope of the claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a block view illustrating a conventional motor power device;

FIG. 2 is a block view illustrating a motor power device according to an embodiment of the present invention;

FIG. 3 is a block view illustrating a motor power device according to another embodiment of the present invention;

FIG. 4 is a circuit diagram illustrating the motor power device of FIG. 2;

FIG. 5 is a circuit diagram illustrating the motor power device of FIG. 3;

FIG. 6 is an exploded perspective view illustrating a motor according to an embodiment of the present invention;

FIG. 7 is a perspective view illustrating some parts of the motor shown in FIG. 6 that are assembled;

FIG. 8 is a perspective view illustrating a down surface of an upper bracket shown in FIG. 6;

FIG. 9 is a plane view illustrating a lower bracket of FIG. 6 fastened to a PCB; and

FIG. 10 is a plane view illustrating a stator of FIG. 6.

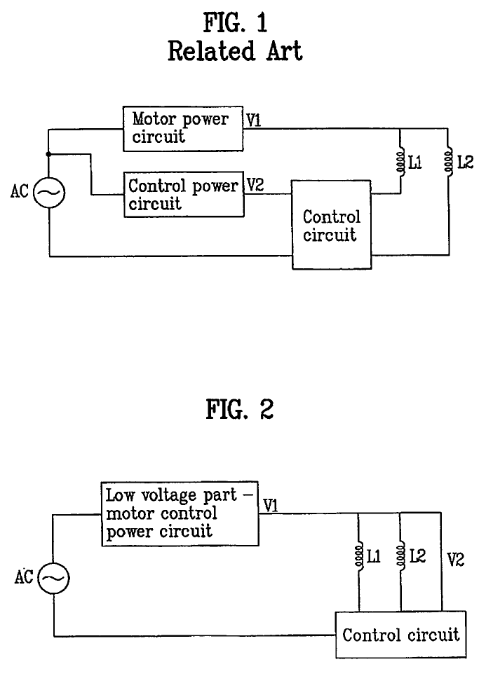

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

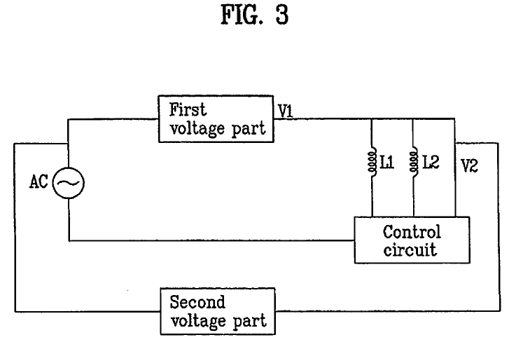

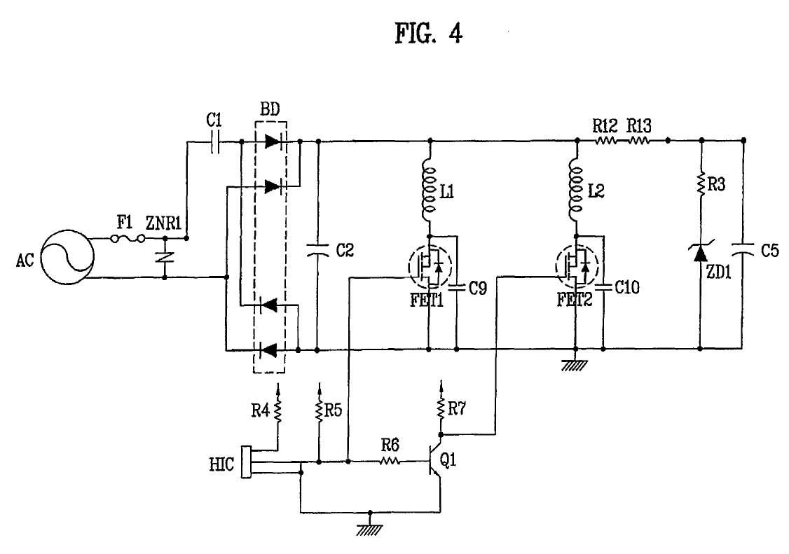

FIGS. 2 and 3 are block diagrams illustrating a power circuit that converts an inputted AC power into low DC voltage. Here, the inputted AC power is an external power that is supplied to the power circuit via a connector. The connector will be described later.

The present application discloses a power circuit supplying DC power and includes a technical feature of converting AC power into low DC voltage, such that a low cost motor power device may be provided when compared with other motor power devices having comparable magnitude of AC power.

Especially, FIG. 2 illustrates an embodiment where power (V1) for a motor drive coil L1 and L2 and power V2 for a control circuit are supplied via one power circuit.

That is, one power circuit may supply power V1 of a motor drive coil and power V2 of a control circuit that controls the motor drive coil.

FIG. 3 illustrates another embodiment where there are separately provided a power circuit (hereinafter, a motor power circuit) supplying power V1 for a motor drive coils L1 and L2 and a power circuit (hereinafter, a control power circuit) supplying power V2 for the control circuit.

AC power is branched/inputted to the motor power circuit and the control power circuit. The motor power circuit and the control power circuit converts this AC power to low voltages.

The motor power device of the embodiments of the present invention will be described in detail.

FIG. 4 illustrates a circuit diagram of the motor power device shown in FIG. 2. The motor power device is formed on a PCB (printed circuit board), which will be described later. A motor drive coil is wound around the teeth of a stator core.

First, the motor drive coil of the motor includes a first coil L1 and a second coil L2.

A control circuit, that controls the power supplied to the motor drive coils L1 and L2, includes a hall integrated circuit (hereinafter, HIC), a signal inverting switch Q1, a first coil control switch FET1 and a second coil control switch FET2. The HIC senses a rotation of a motor to output a square wave output signal. The signal inverting switch Q1 inverts the signal outputted from the HIC. The FET1 is serially connected to the first coil L1 to switch on/off the first coil L1 based on the signal outputted from the HIC. The second coil control switch FET2 is serially connected to the second coil L2 to switch on/off the second coil L2 based on the signal inverted by the signal inverting switch Q1.

Here, a base terminal of the signal inverting switch Q1 is connected to a signal output terminal of the HIC. An emitter terminal of the signal inverting switch Q1 is connected to a ground terminal and a collector terminal of the signal inverting switch Q1 is connected to a gate terminal of the second coil control switch FET2.

A gate terminal of the first coil control switch FET1 is connected to a signal output terminal of the HIC. A source terminal of the first coil control switch FET1 is connected a ground terminal and a drain terminal of the first coil control switch FET1 is connected to the first coil L1.

Also, a gate terminal of the second control switch FET2 is connected to the collector terminal of the signal inverting switch Q1. A source terminal of the second coil control switch FET2 is connected to a ground terminal and a drain terminal of the second coil control switch FET2 is connected to the second coil L2.

That is, an output signal of the HIC is inverted at the gate terminal of the second control switch FET2 such that the gate input signals of the first and second coil control switches FET1 and FET2 are alternated.

A switch protection circuit is provided in this embodiment to remove noise generated during the switching on/off of the first and second coil control switches FET1 and FET2. The switch protection circuit may be protection capacitors C9 and C10 connected in parallel to the first and second coil control switches FET1 and FET2, respectively.

Preferably, the protection capacitors C9 and C10 configured as a switch protection circuit are film capacitors made of PP (Polypopylene).

Accordingly, one power circuit (hereinafter, a motor control power circuit) is provided to supply power V1 for driving the motor drive coils L1 and L2 and power V2 for driving the control circuit.

The motor control power circuit includes a low voltage part, which converts AC power inputted after being serially connected to an AC power supply into low voltage that is used to alternatively generate a gate input signal of the first and second coil control switches FET1 and FET2, and may also include a capacitor C1 for safety.

Here, it is preferred that a capacitive value of the capacitor C1 is selected based on AC power that is used in the country or region in which a product using the same is released.

That is, if the AC power were to change, for example, because the product is being released in a certain country or region, only the capacitor C1 having a capacitive value corresponding to the AC power needs to be changed to supply the DC voltage appropriate to the motor drive coils L1 and L2, and the motor drive coils L1 and L2 themselves do not have to be changed.

Preferably, the safety capacitor C1 is a film capacitor made of PP (Polypropylene).

The motor control power circuit may have a fuse F1 between the AC power terminal and the safety capacitor C1 in order to protect an internal circuitry in case there is a malfunction of the safety capacitor C1 such as a short and the like.

Furthermore, the motor control power circuit may include a varistor ZNR1 connected in parallel with the AC power supply to suppress a surge voltage generated at the AC power supply, a bridge type rectifier diode BD to rectify a low DC voltage outputted via the safety capacitor C1, and a smoothing capacitor C2 connected in parallel to the bridge type rectifier diode BD to smooth the DC voltage rectified at the bridge type rectifier diode BD.

The low DC voltage outputted after being converted from AC power by the motor control power circuit is supplied to power V1 for the motor drive coils L1 and L2.

Power V2 for the control circuit needs a relatively low DC voltage, for example, DC 6˜15V, in comparison with the power V1 for the motor drive coils L1 and L2. Thereby, the motor control power circuit further includes a voltage drop parts that lowers a DC voltage level outputted via the smoothing capacitor C2.

Here, the voltage drop parts are configured to connect at least two resistors (hereinafter, voltage drop resistors) in serial.

The DC voltage V2 lowered via the voltage drop parts R12 and R13 is supplied to the HIC of the control circuit and the driving power of the signal inverting switch Q1.

The voltage drop resistors R12 and R13 are configured to select an appropriate resistor value based on a voltage level required by the control circuit, such that necessary power may be supplied and voltage balance may be maintained between the control circuit and the motor control power circuit.

The motor control power circuit further includes a zener diode ZD1 that regulates and maintains a constant DC voltage outputted from the voltage drop resistors R12 and R13, and a resistor R3 is serially connected to the zener diode ZD1 to protect the zener diode ZD1 from overcurrents.

Here, the resistors may be connected to the zener diode ZD1 in serial to cause the zener diode ZD1 to regulate and output a lower constant DC voltage.

Next, an operation of the motor power device having the above configuration will be described.

Once AC power is applied to the motor control power circuit, the AC power is converted via the safety capacitor C1 and the rectifier diode BD to output a low DC voltage.

Ripples in the DC voltage V1 are smoothed via the capacitor C2. The voltage level of the DC voltage V1 is lowered via the voltage drop resistors R12 and R13 and supplied as power of the control circuit. That is, the DC voltage V2 outputted via the voltage drop resistors R12 and R13 is used as a driving power for both the hall sensor and the signal inverting switch Q1.

Once the DC voltage V2 is applied to HIC, the HIC senses the motor rotation to generate a square wave signal. Hence, the output signal of the HIC is inputted at a gate of the first coil control switch FET1 and a base of the signal inverting switch Q1 at the same time.

Thus, if a high signal is applied to the gate of the first coil control switch FET1, the collector output signal of the signal inverting switch Q1 is an inverse of the above high signal, which is a low signal and the low signal is applied to the gate of the second coil control switch FET2.

The first coil control switch FET1 is switched on to flow electric currents to the first coil L1 and the second coil control switch FET2 is switched off to cut off electric currents of the second coil L2.

Thus, the first coil L1 is magnetized to generate a rotational force and the rotor of the motor rotates 180°. The magnetic polarity sensed by the HIC is now opposite to that before the 180° rotation, and thus the HICgenerates an output signal having an opposite phase. Hence, the first coil control switch FET1 is switched off and the second coil control switch FET2 is switched on.

Due to the switching operation, the second coil L2 is magnetized to rotate the rotor of the motor 360° and the rotational inertia force rotates the rotor of the motor in the same direction as when the first coil L1 was magnetized.

Thus, this embodiment has an advantageous effect in that the power V1 of the motor drive coils L1 and L2 and the power V2 of the control circuit are supplied via one circuit, as well as the effect that safe power is supplied by only the varying the capacitive value of the safety capacitor C1 even though the AC power has changed.

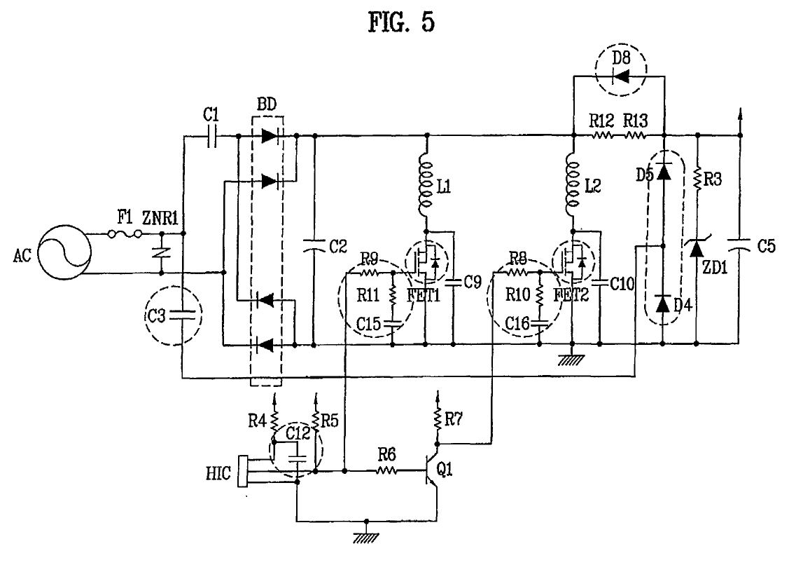

Next, referring to FIGS. 3 and 5, another motor power device according to an embodiment of the present invention will be described.

FIG. 5 illustrates a specific circuit diagram of the motor power shown in FIG. 3.

These embodiments may have similar motor drive coils L1 and L2 and the control circuit as those of the above embodiment. A motor power circuit for supplying the power V1 of the motor drive coils L1 and L2 and a control power circuit for supplying the power V2 of the control circuit may be separately designed, which is different from the above embodiment.

A motor power circuit, which is the same as the motor control power circuit of the above embodiment, includes a safety capacitor C1, a bridge rectifier diode BD and a smoothing capacitor C2.

That is, AC power is converted via the capacitor C1 and rectified/smoothed via the bridge rectifier diode and the smoothing capacitor C2. Hence, it is outputted as a low DC voltage.

The outputted DC voltage V1 is applied to the motor drive coils L1 and L2 to drive the motor.

The control power circuit includes a safety capacitor C3 branched from an AC power terminal to receive/convert the AC power.

Here, the safety capacitor C3 may be a film capacitor made of the same material as the capacitor C1.

The control power circuit further includes voltage drop resistors R12 and R13, and rectifier diodes D4 and D5. The voltage drop resistors R12 and R13 lower the DC voltage level outputted from the bridge rectifier diode BD to create a DC voltage level suitable for the control circuit. The rectified diodes D4 and D5 receive/rectify the low DC voltage outputted via the safety capacitor C3.

Preferably, the rectifier diodes D4 and D5 are a single-phase rectifier circuit.

Also, the control power circuit further includes a zener diode ZD1 that regulates and maintains a constant DC voltage outputted from the voltage drop resistors R12 and R13 and the rectifier diodes D4 and D5. A resistor R3 is serially connected to the zener diode ZD1 to protect the zener diode ZD1 from overcurrents.

Thereby, the DC voltage outputted from the control power circuit is supplied to drive the HIC and the signal inverting switch Q1 of the control circuit.

The operation of the motor drive coils L1 and L2 that receives power via the motor power circuit and the operation of the control circuit that receives power via the control power circuit are the similar as those described in the above embodiment.

The embodiment described immediately above presents the power device having separate motor power circuit and control power circuit. Also, a safe power may be supplied by varying the capacitive value of the safety capacitors C1 and C3, even though the AC power has changed.

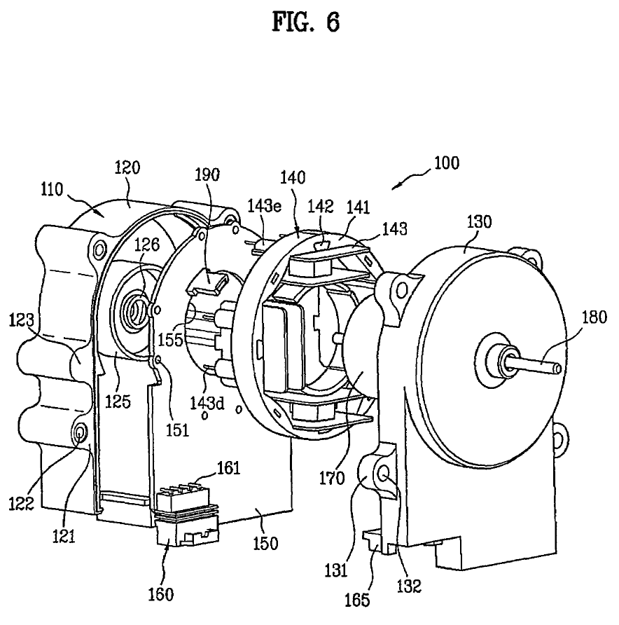

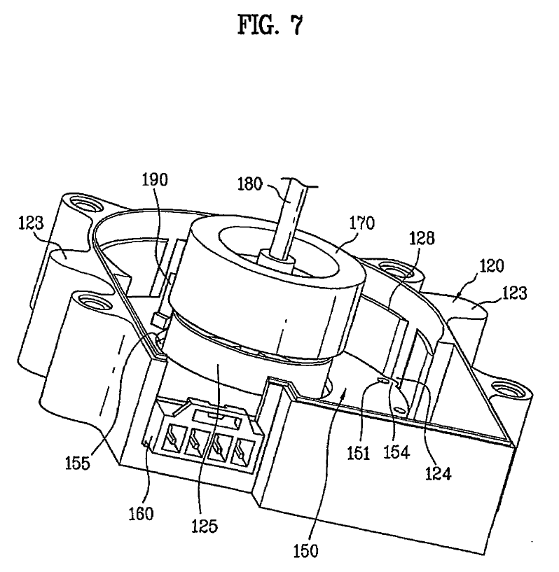

Next, referring to FIGS. 6 to 10, a motor including the power device described above will be described in detail.

FIG. 6 is an exploded perspective view of a motor 100 according to an embodiment of the present invention.

As shown in FIG. 6, a motor includes a bracket 110, a PCB (printed circuit board) 150, a stator 140, a rotor 170 and a shaft 180. The bracket 110 defines an exterior of the motor. The PCB 150 is held within the bracket 110 and a circuit pattern (not shown). Also, various elements (not shown) are mounted in the PCB 150.

The bracket 110 includes a lower bracket 120 and an upper bracket 130. The lower and upper brackets 120 and the 130 are coupled each other to hold various components therein. To couple the lower and upper brackets 120 and 130 to each other, fastening bosses 121 and 131 may be fastened through fastening holes 122 and 132 formed on the fastening bosses 121 and 131 by a screw (not shown).

Referring to FIGS. 6 and 10, the stator 140 of the motor according to an embodiment of the present invention will be described in detail.

The stator 140 includes a stator core 141 and a tooth 142.

As shown in the above drawings, the stator core 141 may be formed in a circular shape and forms a magnetic path. The tooth 142 is projected in a radial direction of the stator core 141 and a coil is wound around the tooth 142. The motor shown in the drawings is embodied as an inner rotor type motor in which a rotor is provided within a stator core 141. Thus, the tooth 142 is projected inwardly in a radial direction. A plurality of teeth 142 may be formed and FIG. 5 shows that four of teeth 142 are formed.

A plurality of tooth parts 144 are alternated with a plurality of extending parts 145 along an inner circumferential direction of the stator core 141. Here, the teeth 142 are provided on the tooth parts 144, respectively. The extending part 145 is extending convexly and inwardly in a radial direction.

The extending part 145 may be extending inwardly and convexly between the two neighboring tooth parts 144 in a radial direction. Preferably, the extending part 145 increases its thickness entirely to secure enough space needed in forming a magnetic flux. Thereby, a leakage flux due to a high saturation on flux density is minimized to maximize an efficiency of the motor, and the thickness of the stator core 141 increases to reinforce a structural strength of the stator core 141.

Alternatively, the extending part 145 may be formed outwardly in a radial direction. But, this may enlarge the size of the stator core 141, and thereby enlarge the entire size of the motor.

The stator core 141 may be formed by multi-layering a plurality of unit stator cores. That is, a plurality of thin unit stator cores may be multi-layered to form a stator core 141 having a predetermined height. The stator core 141 formed by multi-layered unit stator cores may minimize a leakage flux, which may be formed in a perpendicular direction of the magnetic flux, to enhance efficiency of the motor. It is also preferred that the teeth 142 are also formed by a multi-layering method.

If the stator core 141 is formed by multi-layering the unit stator cores, the stator cores 141 may be fastened to each other as one body. That means that one stator core 141 formed as one body is necessary. Thus, a caulking part 146 may be provided to fasten the stator cores 141 to each other. The caulking part 146 is formed on the stator core 141, more specifically, as a portion having a wide width. The caulking part 146 passes through an upper and lower part of the stator core 141 to minimize a leakage flux or a fringing flux due to the caulking part 146.

The caulking part 146 may be formed on the extending part 145. Preferably, the caulking part 146 is formed on a center of the extending part 145, which has the widest width.

Thereby, it is possible to perform secure caulking. The caulking part 146 may minimize distortion of the stator core 141 and prevents efficiency deterioration.

Meanwhile, the teeth 142 may be formed as one body with the stator core 141, that is, the teeth 142 may be formed as one body with the stator core 141 from the beginning. Alternatively, the teeth 142 are formed separately from the stator core 141 and fastened to the stator core 141 to make easy the fabrication of the stator 140 as well as winding.

A tooth slot 147 is formed in a center of the tooth part 144 formed on the stator core 141 and an end of the tooth 142 is inserted in the tooth slot 147 to fasten the tooth 142 to the stator core 141.

Thus, a tooth 142 is inserted in a bobbin 143 and a coil is wound around the bobbin 143 to insert the tooth 142 in the tooth slot 147, such that the fastening between the bobbin 143 and the tooth 142, and winding may be smooth.

Next, a groove 148 may be formed on an outer circumferential surface of the stator core 141 in a longitudinal direction of the stator core 141. Preferably, a plurality of grooves 148 may be formed along circumferential direction of an outer surface of the stator core 141.

The groove 148 also helps the unit stator cores to separate from a blanking mold when the unit stator cores are blanked and molded. More specifically, the groove 148 makes the internal pressure of the mold same as the external pressure to smoothly separate the unit stator cores from the mold. Furthermore, the groove 148 guides the unit stator cores.

It is preferred that the groove 148 is formed on an outer portion of the tooth part 147 formed on the stator core 141 to minimize variation of core size caused when the tooth 142 is inserted in the tooth slot 147. Thus, to perform this function, it is preferred that the groove 148 corresponds to a center of the tooth slot 147.

It is preferred that a coil is wound around the bobbin 143 configured for insulation so that winding between a coil and the tooth 142 is done without any difficulties, instead of directly winding a coil around the tooth 142.

The bobbin 143 may be configured as an inner wall 143b, a winding part 143b and an outer wall 143c. A coil is wound around the winding part 143b between the inner wall 143a and the outer wall 143c, and the inner wall 143a and the outer wall 143c prevent the coil from coming outside.

Here, the outer wall 143c of the bobbin 143 is contacted with the tooth part 144 provided on the stator core 141. Preferably, an inner wall of the tooth part 144 is plane to be contacted with the outer wall 143 of the bobbin 143, such that the bobbin 143 may be coupled to the stator core 141 more securely.

By the way, the motor may have four teeth 142, for example, as shown in FIG. 5. Hence, if the power is applied to the coil wound around the tooth 142, an N-pole and an S-pole are alternatively formed on each tooth 142. As shown in FIG. 5, if an N-pole is formed on a tooth 142 provided on most upper position, an S-pole is formed on neighboring teeth.

Polarity is formed on the teeth 142 and a leakage flux increases as the distance between the teeth gets farther and farther. Thus, a pole shoe 149 may be formed on a front end of each tooth 142 to minimize a leakage flux and to extend in predetermined length in both opposite circumferential directions to be fixedly contacted with an outer surface of the rotor 170. Thereby, a leakage flux caused between the two neighboring teeth may be minimized.

As shown in FIG. 10, the pole shoe 149 formed on one tooth 142 may not be connected to the next pole shoe 149 formed on another neighboring tooth 142. This is because two different polarities are formed on two neighboring pole shoes 149, respectively. If the two neighboring pole shoes 149 are connected, polarity may deteriorate.

Together with the pole shoe 149 formed to minimize a leakage flux, it is preferred to reduce cogging torque or torque ripple generated from the shaft 180 and the rotor 170 due to drastic change of polarity between teeth. This is because the cogging torque makes the control of motor difficult and causes vibration or noise.

Accordingly, it is preferred to smooth down the drastic change of polarity between two neighboring teeth.

Accordingly, a cogging torque reduction part may be formed on the pole shoe 149 to prevent polarity from changing drastically, such that cogging torque may be minimized.

The cogging torque reduction part may be formed at both ends of the pole shoe in a circumferential direction, respectively, or the cogging torque reduction part may be formed only at a first end of the pole shoe in a circumferential direction. This is because the magnetic polarity is changed at the end of the pole shoe 149 and the end of the neighboring pole shoe.

Meanwhile, the cogging torque reduction part may reduce magnetic flux density and the width of the cogging torque reduction part may be narrower than the portion of the pole shoe 149. As an example, the cogging torque reduction part may be a cut part 149a formed at the end of the pole shoe 149. The cut part 149a may reduce the magnetic flux density to prevent a magnetic polarity from changing drastically. The cut part may increase the leakage flux. Thus, it is preferred that the cut part is formed at only one end of the pole shoe 149.

In particular, the cut part 149a may be formed in a direction that expands air gap between the rotor 170 and the tooth. The cut part 149a may face the rotor. This is because permanent magnets (not shown) are alternatively provided along a circumferential surface of the rotor 170 and it is preferred to increase air gap, related to the permanent magnet of the rotor.

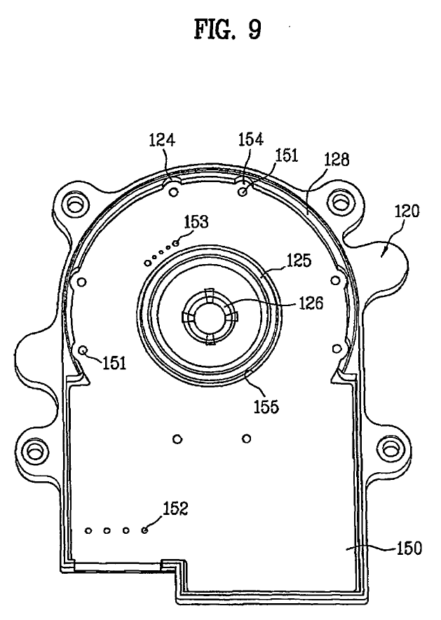

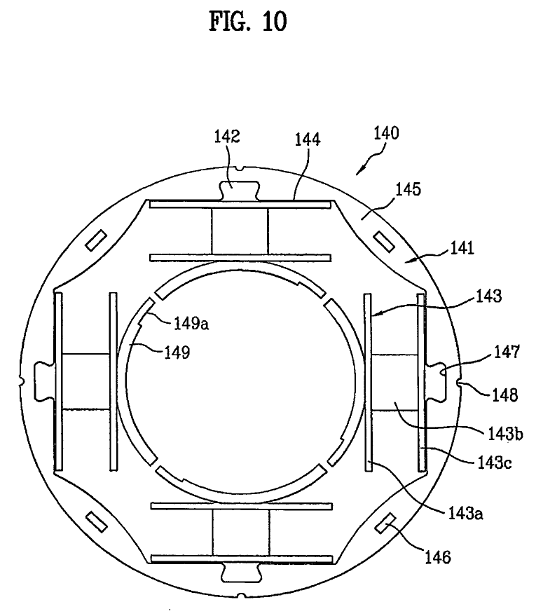

As shown in FIGS. 6 and 9, a stator 140 of the motor according to an embodiment of the present invention may be formed in a circular shape. Corresponding to the shape of the stator 140, at least some portion of the PCB 150 may be formed in a circular shape. As shown in FIGS. 6 and 10, an upper portion of the PCB 150 may be formed in a circular shape, where the stator 140 is seated.

A radius of the circular portion of the PCB 150 may be substantially same as that of the stator core 141. A large sized exterior of the PCB 150 may enlarge the size of the bracket 110. Hence, the entire size of the motor may become large. Accordingly, some portion of the PCB 150 may be formed in a circular shape to provide a compact sized motor.

Furthermore, because the shape of the bracket 110 corresponds to the shape of the PCB 150, exterior beauty of the motor may be enhanced.

By the way, fin 143d is formed on a lower both opposite sides of the bobbin 143. The fin 143d is electrically connected to the coil wound around the bobbin 143. Thus, the fin 143d is inserted in a hole 151 formed on the PCB 150 to connect the PCB 150 to the coil. Once the fin 143d is inserted in the hole 151 of the PCB 150, soldering may be performed for secure electrical connection.

The fin 143d helps the stator 140 to seat on an upper portion of the PCB 150 by using the bobbin 143, as well as electrically connect the PCB 150 to the coil. Thus, the fin 143d is formed on the boss 143e to enlarge a contact section with the PCB 150 and to carry the weight of the stator 140.

The boss 143e is formed in a lower portion of the outer wall 143c to maintain a distance between the PCB 150 and the stator core 141.

By the way, a connector 160 is provided on a side of the PCB 150. A fin 161 is formed on an end of the connector 160 and the connector 160 is fixed to the PCB 150 through the fin 161, to electrically connect to the PCB 150. The fin 161 is inserted in a hole 152 formed on the PCB 150 and the other end of the connector 160 is exposed outside of the motor, that is outside of the bracket 110, to be connected to an external power.

Furthermore, a hall sensor assembly 190 is provided on a portion of the PCB 150 corresponding to the position of the rotor 170. The hall sensor assembly 190 senses a rotation position or a rotational speed of the rotor 170 to control a rotation speed or torque of the rotor 170. Thus, a hole 153 is formed on the PCB 150 to fix the hall sensor assembly 190 and to electrically connect the hall sensor assembly 190 to the PCB 150.

Because four teeth 142 are provided in the motor of this example, four portions to which four bobbins 143 are coupled are provided.

As shown in FIGS. 6 and 10, some portion of the PCB 150 is formed in a circular shape. A predetermined number of the four portions are formed on a circular shaped portion of the PCB 150. As described above, this circular shaped portion corresponds to the circular shape of the stator 140.

To provide a motor having a compact size by lessening the size of the PCB 150, a predetermined number of holes 151 may be formed on an outermost portion of the circular shaped PCB portion. That is, a predetermined number of holes 151 may be formed on a circumference of the PCB 150. Because the strength of the portion having the holes 151 formed thereon is weak, there may be a malfunction when forming the holes 151 or there may be damage to the holes 151 due to vibration and the like.

For this, it is preferred that an extension part is extended outwardly on a portion in which every hole 151 is formed. In other words, the extension part 154 secures a predetermined distance between the holes 151 and the outermost portion of the PCB 150, such that the strength of the PCB 150 is reinforced and the external shape of the PCB 150 is prevented from getting large. Furthermore, the extension part 154 enables the PCB 150 to be seated on the bracket 110 smoothly.

A hollow portion 155 is formed on the PCB 150. The hollow portion 155 may be formed on a center of the PCB 150 and a stopper, which will be described later, is inserted in the hollow portion 155 to prevent interference between the rotor 170 and the PCB 150.

Also, because the stopper is inserted in the hollow portion 155, the PCB 150 may be securely fixed to the bracket 110.

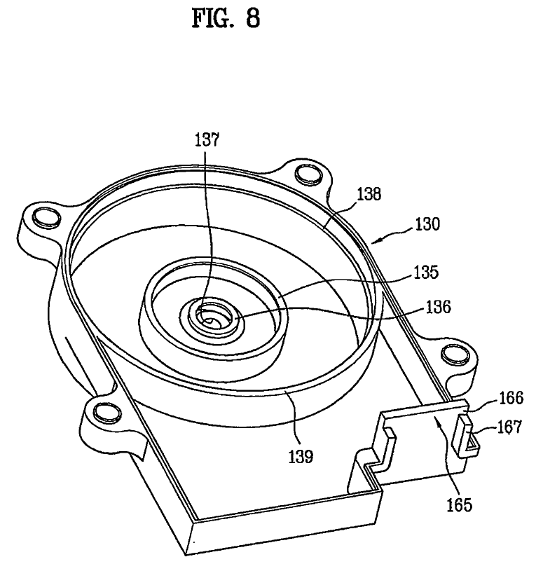

Next, referring to FIGS. 7 and 8, the bracket 110 of the motor according to an embodiment of the present invention will be described in detail.

As mentioned before, the bracket 110 includes a lower bracket 120 and an upper bracket 130 coupled to each other to hold various components. The lower bracket 120 may include a mounting part 123 that mounts the motor 100 to various parts the motor applied to.

The shape of the bracket 110 corresponds to that of the PCB 150. The PCB 150 is seated within the bracket 110, more specifically within the lower bracket 120.

A groove 124 corresponding to the extension part 154 may be formed on the lower bracket to seat the extension part 154 therein. This may make the position of the PCB 150 to automatically align when the PCB 150 is seated on the lower bracket 120, and even seat more securely.

A step part 128, which will be described later, may be formed on the lower bracket 120 to mount the stator to the lower bracket 120. The step part 128 is projected a predetermined distance from an inner wall of the lower bracket 120. Preferably, the groove 124 cuts into some portion of the step part 128 to prevent the shape of the bracket from being large due to the groove 124.

As shown in FIG. 7, the PCB 150 is mounted within the lower bracket 120. As described above, a stopper 155 is inserted in the hollow portion 155 formed on the PCB 150.

Hence, the stator 140 is imparted on the PCB 150, and the rotor 170 and the shaft 180 are provided within the stator 140.

An end of the shaft 180 is rotatably supported by the bearing 126 provided in the lower bracket 120 and a thrust is supported, too. The other end of the shaft 180 is rotatably supported by the bearing 136 provided in the upper bracket 120. Here, the shaft is exposed outside through the through hole 137 to drive load.

The shaft 180 may be inserted in the rotor 170 to rotate as one body with the rotor 170, such that the rotor 170 is prevented from moving in a longitudinal direction of the shaft 180. This is shown in FIG. 7.

However, the rotor 170 may move in a longitudinal direction of the shaft due to vibration. This may cause interference between the rotor 170 and the PCB 150 and damage the PCB 150.

Due to those problems, a stopper 125 may be formed and prevents the rotor 170 from moving toward the shaft 180. The stopper 125 may project from an inside of the bracket and may be formed as one body with the bracket.

The stopper 125 formed as one body with the lower bracket 120 is shown in FIGS. 6 and 7.

Preferably, a stopper 135 may be formed in the upper bracket 130 as one body with the upper bracket 130, too. The rotor 170 may be provided between the both stoppers 125 and 135.

Thus, the stoppers 125 and 135 may prevent interference between the bracket 110 and the PCB 150 even though the rotor 170 may move toward the shaft 180.

The stoppers 125 and 135 may be projected in a cylindrical shape. This is because it is preferred that the stopper corresponding to the rotor 170 have a cylindrical shape. Also, an upper surface of the stopper 125 or 135 contacts with an upper or lower surface of the rotor 170. An outer or inner diameter of the stopper 125 and 135 may be determined for that.

The stator 140 is securely fixed within the bracket 110. For this, a step part 128 and/or 138 is formed on a lower and upper bracket 120 and/or 130, respectively.

The stator 140, more specifically an outer circumferential surface of the stator core 141, is seated on the step part 128 and 138. Hence, as the upper bracket 130 is coupled to the lower bracket 120, the stator 140 is securely fixed between the step parts 128 and 138.

Since the PCB 150 has been already seated on the lower bracket 120, it is difficult to form the step part 128 corresponding to the entire circumference of the stator core 141. Thus, the step part 138 may be formed corresponding to the entire circumference of the stator core 141. For this, it is preferred that an inner partition wall 139 is further formed within the upper bracket 130.

Alternatively, an inner partition wall may be formed in the lower bracket, too. If so, a through hole (not shown) may be formed on the PCB 150 so that the inner partition wall may pass there through. Thereby, this may not be preferred.

Therefore, the following advantageous effects may be obtained.

According to the power device supplying low DC voltage to the motor by using AC power, there is an advantageous effect in that the simple replacement of parts may convert the AC power even though the AC power is changed based on a region. Replacement of the coils and a switching element due to increased AC power may be avoided, and thereby facilitating a more productive process and structure variation.

Furthermore, because one power circuit can supply the power for driving the motor and the power for the motor control circuit, an auxiliary power supply device is not required. Thereby, there is another advantageous effect that production cost may be reduced as well as minimizing the size of a product.

Also, the motor including the motor power device has following advantageous effects.

First, the motor may be fabricated without difficulties and the exterior of the motor is compact. Thus, there is an advantageous effect that space for the motor may be reduced, and thereby the motor has even wider applications.

Second, the motor reduces a leakage flux. Thus, there is another advantageous effect that motor efficiency is enhanced with minimal electricity loss.

Third, the motor has a further advantageous effect in that it may minimize vibration by reducing cogging torque and control the rotational speed of the shaft and torque smoothly.

Finally, the motor may prevent malfunctions that may be generated in the fabrication process or usage. Thus, there is a further advantageous effect in that a motor having high reliability as well as high durability may be provided.

It will be apparent to those skilled in the art that various modifications and variations can be made without departing from the spirit or scope of the inventions. Thus, it is intended that the present invention covers the modifications and variations provided they come within the scope of the appended claims and their equivalents.

What is claimed is:

1. A motor power device comprising:
a power circuit comprising a low voltage part that receives and converts AC power to output low DC voltage,
wherein a first power for a motor drive coil and a second power for a control circuit controlling the motor drive coil are supplied by using the low DC voltage outputted from the power circuit.

2. The motor power device of claim 1, wherein the low voltage part comprises a capacitor that converts the inputted AC power based on a capacitive value of the capacitor.

3. The motor power device of claim 2, wherein the capacitive value of the capacitor is selected based on a magnitude of the AC power.

4. The motor power device of claim 2, wherein the capacitor is a film capacitor.

5. The motor power device of claim 2, wherein the capacitor is a film capacitor made of polypropylene.

6. The motor power device of claim 1, wherein the power circuit further comprises a protection circuit connected between an AC power terminal and the low voltage part in serial to protect the power circuit against a malfunction of the low voltage part.

7. The motor power device of claim 6, wherein the protection circuit comprises a fuse configured as a circuit beaker.

8. The motor power device of claim 1, wherein the power circuit further comprises a rectifier circuit connected to a rear terminal of the low voltage part to rectify the DC voltage outputted from the low voltage part.

9. The motor power device of claim 8, wherein the power circuit further comprises a smoothing circuit connected to the rectifier circuit in parallel to smooth the DC voltage rectified at the rectifier circuit.

10. The motor power device of claim 8, wherein the power circuit further comprises a voltage drop part connected to an output terminal of the rectifier circuit to lower a DC voltage value outputted at the rectifier circuit, wherein the DC voltage outputted at the rectifier circuit is configured as a second power for a control circuit.

11. The motor power device of claim 10, wherein the voltage drop part is configured as at least two resistors in serial.

12. The motor power device of claim 10, wherein the power circuit further comprises a zener diode that regulates and maintains the DC voltage outputted at the voltage drop part.

13. The motor power device of claim 12, further comprising a resistor connected to the zener diode in serial to protect the zener diode from overcurrents.

14. The motor power device of claim 1, wherein the motor drive coil comprises a first coil and a second coil, wherein the control circuit further comprises,
a HIC (Hall Integrated Circuit) that senses a rotation of a motor to output a square wave output signal,
a signal inverting switch that inverts the output signal of the HIC,
a first coil control switch connected to the first coil in serial to switch the first coil on and off based on the output signal outputted at the first coil, and
a second coil control switch connected to the second coil in serial to switch the second coil on and off based on the output signal inverted at the signal inverting switch.

15. The motor power device of claim 14, wherein the control circuit further comprises switch protection circuits connected to the first coil control switch and the second coil control switch, respectively, to remove noise generated when the first and second coil control switches are switched on and off.

16. The motor power device of claim 15, wherein the switch protection circuit is a film capacitor made of polypropylene.

17. A motor power device comprising:
a motor power circuit comprising a first low voltage part that receives and converts AC power to output a DC voltage, and
a control power circuit comprising a second low voltage part that receives and converts the AC power to output a low DC voltage,
wherein a first power for a motor drive coil is supplied by using the DC voltage outputted at the motor power circuit and a second power for controlling the motor drive coil is supplied by the low DC voltage outputted at the control power circuit.

18. The motor power device of claim 17, wherein the first and second low voltage parts comprise capacitors, respectively, that converts the AC power based on the capacitive value of the capacitor.

19. The motor power device of claim 18, wherein the capacitive value of the capacitor is selected based on a magnitude of the AC power.

20. The motor power device of claim 18, wherein the capacitor is a film capacitor.

21. The motor power device of claim 18, wherein the capacitor is a film capacitor made of polypropylene.

22. The motor power device of claim 17, further comprising a protection circuit connected to each front terminal of the first and second low voltage part to protect the motor power circuit and the control power circuit against is a malfunction of the first and second low voltage part.

23. The motor power device of claim 22, wherein the protection circuit comprises a fuse as a circuit breaker.

24. The motor power device of claim 17, wherein the motor power circuit further comprises a rectifier circuit connected to a rear terminal of the first low voltage part to rectify the DC voltage outputted at the first low voltage part.

25. The motor power device of claim 24, further comprising a smoothing circuit connected to the rectifier circuit in parallel to smooth the DC circuit rectified at the rectifier circuit.

26. The motor power device of claim 17, wherein the control power circuit further comprises a rectifier circuit connected to the motor drive coil in parallel to receive and rectify the DC voltage outputted at the second low voltage part, wherein the DC voltage outputted at the rectifier circuit is configured as a second power for the control circuit.

27. The motor power device of claim 26, wherein the rectifier circuit is configured as at least two rectifier diodes in serial.

28. The motor power device of claim 26, wherein the control power circuit further comprises a zener diode that regulates and maintains the DC voltage outputted at the rectifier circuit.

29. The motor power device of claim 28, further comprising a resistor connected to the zener diode in serial to protect the zener diode from overcurrents.

30. The motor power device of claim 17, wherein the motor drive coil comprises a first coil and a second coil, wherein the control circuit further comprises,
a HIC (Hall Integrated Circuit) that senses a rotation of a motor to output a square wave output signal,
a signal inverting switch that inverts the output signal of the HIC,
a first coil control switch connected to the first coil in serial to switch the first coil on and off based on the output signal outputted at the first coil, and
a second coil control switch connected to the second coil in serial to switch the second coil on and off based on the output signal inverted at the signal inverting switch.

31. The motor power device of claim 30, wherein the control circuit further comprises switch protection circuits connected to the first coil control switch and the second coil control switch, respectively, to remove noise generated when the first and second coil control switches are switched on and off.

32. The motor power device of claim 31, wherein the switch protection circuit is a film capacitor made of polypropylene.

33. A motor comprising:
a bracket that defines an exterior of the motor;
a PCB (printed circuit board) held within the bracket and having a circuit pattern and various elements mounted thereon;
a stator provided on the PCB;
a rotor provided within the stator to rotate;
a shaft that rotate together with the rotor to transmit a rotational force of the rotor outside; and
a motor power device comprising a power circuit comprising a low voltage part that receives and converts AC power and outputs DC voltage, wherein a first power for a motor drive coil and a second power for a control circuit controlling the motor drive coil are supplied by using the DC voltage outputted from the power circuit.

34. A motor comprising:
a bracket that defines an exterior of the motor;
a PCB (printed circuit board) held within the bracket and having an circuit pattern and various elements mounted thereon;
a stator provided on the PCB;
a rotor provided within the stator that rotates;
a shaft that rotate together with the rotor to transmit a rotational force of the rotor outside; and
a motor power device comprising a motor power circuit comprising a first low voltage part that receives and converts AC power to output DC voltage, and a control power circuit comprising a second low voltage part that receives and converts the AC power to output low DC voltage, wherein a first power for a motor drive coil is supplied by using the DC voltage outputted at the motor power circuit and a second power for controlling the motor drive coil is supplied by the low DC voltage outputted at the control power circuit.
